(19) United States
(12) Patent Application Publication
(10) Pub. No.: US 2012/0163449 A1
(43) Pub. Date: Jun. 28, 2012

(54) IMAGE PROCESSING APPARATUS AND METHOD

(75) Inventor: Naohiko KOTAKA, Tokyo (JP)

(73) Assignee: Sony Corporation, Tokyo (JP)

(21) Appl. No.: 13/272,384

(22) Filed: Oct. 13, 2011

(30) Foreign Application Priority Data
Dec. 24, 2010 (JP) 2010-287964

(51) Int. Cl. H04N 7/26

(52) U.S. Cl. 375/240.03; 375/E07.139

(57) ABSTRACT

An image processing apparatus accumulates information generated corresponding to an input image to a buffer and obtains the accumulated information to perform arithmetic encoding. The image processing apparatus includes a calculating unit which calculates an allowable quantity of the information accumulatable in the buffer for each predetermined unit of the input image, based on a maximum accumulation amount of the buffer and an information quantity of the information generated for each predetermined unit of the input unit; and a generating unit which generates the information with an information quantity according to the allowable quantity calculated by the calculating unit.

### BACKGROUND

The present disclosure relates to an image processing apparatus and method, and more particularly, to an image processing apparatus and method capable of preventing an overflow from occurring in a buffer.

In the related art, as an entropy encoding method of H.264/AVC standard recommended by ITU-T (International Telecommunication Union Telecommunication Standardization Sector) as a compression encoding standard of video data, for example, there is an encoding method using a CABAC (Context-Based Adaptive Binary Arithmetic Coding) process.

In an encoding device executing the CABAC process, it has been proposed that a buffer be installed between an encoding processing unit which performs encoding processes such as intra prediction, motion compensation (MC), orthogonal transformation and quantization and a CABAC processing unit which performs CABAC so that the encoding process and the CABAC process are performed asynchronously (for example, Japanese Unexamined Patent Application Publication No. 2003-259370 and International Patent Pamphlet WO 2005/41420. By this, since the CABAC process and the encoding process may be performed in parallel, the processing load may be distributed, which allows the hardware size and the consumed power to be reduced.

In the above encoding device, syntax elements (SE) serving as an orthogonal transformation coefficient or macro block header (MB header) quantized by the encoding process are binarized, the binarized symbol (bin) is accumulated (maintained) in the buffer, and the CABAC processing unit obtains the bin accumulated in the buffer and performs the CABAC process to output a bit stream.

### SUMMARY

However, in the encoding device described above, since the state of the buffer is not managed, there is a possibility that a bin beyond the capability of the CABAC processing unit is supplied to the buffer from the encoding processing unit. In this case, the CABAC process by the CABAC processing unit may not be performed on time and the buffer may overflow such that the bin provided to the CABAC processing unit is destroyed, such that the CABAC processing unit may not output a normal bit stream.

It is desirable to more securely prevent an overflow from occurring in a buffer.

The encoding device according to an embodiment of the present disclosure accumulates information generated corresponding to an input image to a buffer and obtains the accumulated information to perform arithmetic encoding and includes a calculating unit for calculating an allowable quantity of the information accumulatable in the buffer for each predetermined unit of the input image, based on a maximum accumulation amount of the buffer and an information quantity of the information generated for each predetermined unit of the input unit, and a generating unit for generating the information with an information quantity according to the allowable quantity calculated by the calculating unit.

The image processing apparatus may further include a coefficient setting unit for setting all coefficients for a macro block in the input image to be 0 (zero), in a case where the allowable quantity calculated for each picture of the input image is smaller than a predetermined threshold.

The image processing apparatus may further include a parameter adjusting unit for increasing a quantization parameter value of the macro block, in a case where a value according to the information quantity of the information generated for each macro block of the input unit for the allowable quantity calculated for each picture of the input image is greater than a first threshold.

The image processing apparatus may further include a minimizing unit for minimizing the information quantity of the information generated for each macro block, in a case where a value according to the information quantity of the information generated for each macro block of the input image for the allowable quantity calculated for each picture of the input image is greater than a second threshold which is different from the first threshold.

In an editing process for cutting and compiling a first input image and a second input image, in a case where a region where the first input image and the second input image are compiled is re-encoded, the calculating unit may set a first information quantity in the buffer for a picture just before the re-encoding section in the first input image to be 0 (zero), set a second information quantity in the buffer for a picture just after the re-encoding section in the second input image to be a maximum accumulation amount of the buffer, and calculate the allowable quantity for each picture in the re-encoding section for the first input image and the second input image.

The calculating unit may calculate the allowable quantity of the information accumulatable in the buffer by applying an HRD (Hypothetical Reference Decoder) model.

An encoding method of an image processing apparatus according to an embodiment of the present disclosure accumulates information generated corresponding to an input image to a buffer and obtains the accumulated information to perform arithmetic encoding and includes calculating an allowable quantity of the information accumulatable in the buffer for each predetermined unit of the input image, based on a maximum accumulation amount of the buffer and an information quantity of the information generated for each predetermined unit of the input unit; and generating the information with an information quantity according to the allowable quantity calculated by the calculating.

According to an embodiment of the present disclosure, an allowable quantity of the information accumulatable in the buffer for each predetermined unit of the input image is calculated, based on a maximum accumulation amount of the buffer and an information quantity of the information generated for each predetermined unit of the input unit, and the information with an information quantity according to the calculated allowable quantity is generated.

According to an embodiment of the present disclosure, it is possible to more reliably prevent overflow from occurring in a buffer.

### BRIEF DESCRIPTION OF THE DRAWINGS

FIG. 1 is a block diagram showing a configuration of an embodiment of an encoding device according to the present disclosure;

FIG. 2 is a flowchart illustrating a generated bin quantity control process by the encoding device of FIG. 1;

FIG. 3 is a diagram illustrating transition of AVAILABLE_BIN;

FIG. 4 is a diagram illustrating transition of bin_buffer_fullness;

FIG. 5 is a diagram illustrating an example of smart rendering editing;

FIG. 6 is a block diagram showing a configuration of an image editing device;

FIG. 7 is a diagram illustrating transition of AVAILABLE_BIN;

FIG. 8 is a flowchart illustrating a generated bin quantity control process by the image editing device of FIG. 6;

FIG. 9 is a diagram illustrating transition of AVAILABLE_BIN; and

FIG. 10 is a block diagram showing a configuration example of computer hardware.

### DETAILED DESCRIPTION OF EMBODIMENTS

Hereinafter, embodiments of the present disclosure will be described with reference to the drawings.

[Configuration of Encoding Device]

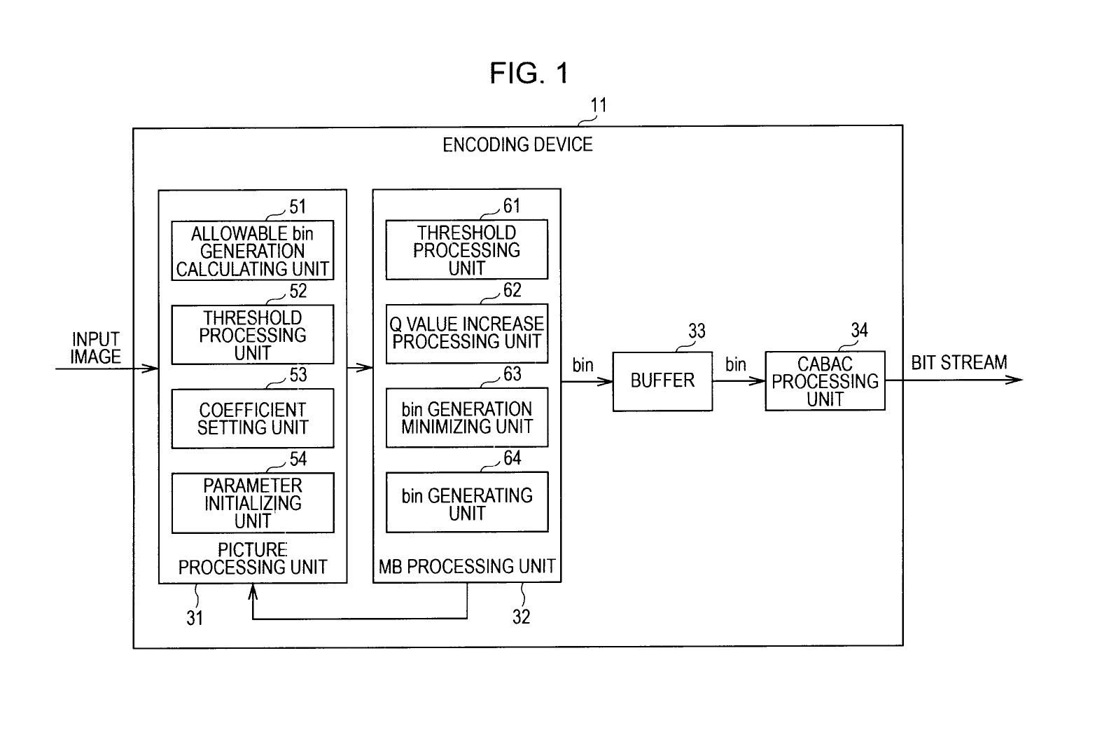

FIG. 1 shows a functional configuration of an embodiment of an encoding device serving as an image processing apparatus according to the present disclosure.

The encoding device 11 of FIG. 1 conforms to the standards of H.264 and MPEG-4 Part 10 Advanced Video Coding (H.264/AVC), and encodes input images to output a bit stream.

The encoding device 11 includes a picture processing unit 31, a macro block (MB) processing unit 32, a buffer 33, and a CABAC (Context-Adaptive Binary Arithmetic Coding) processing unit 34.

The picture processing unit 31 performs an initiating process or the like necessary in the MB processing unit 32 for each picture with regard to successively introduced input images (moving pictures) to be encoded, and supplies the obtained parameters and input image to the MB processing unit 32.

The MB processing unit 32 performs encoding processes such as inter prediction, motion compensation (MC), orthogonal transformation, quantization, or the like for each macro block (MB) with regard to the input image of each picture from the picture processing unit 31. The MB processing unit 32 binarizes quantized transform coefficients or syntax elements (SE) serving as an MB header, obtained by the encoding process, into a binary string, and supplies one bit at a time to the buffer 33 as a symbol (bin).

The buffer 33 temporarily accumulates the bin from the MB processing unit 32.

The CABAC processing unit 34 obtains (reads) the bin from the buffer 33 and performs an arithmetic encoding process to the CABAC to output a bit stream as a result of encoding.

In addition, in the encoding device 11, the bin quantity supplied to the buffer 33 (hereinafter, referred to as generated bin quantity) is controlled. In detail, the picture processing unit 31 controls a generated bin quantity for each picture, and the MB processing unit 32 controls a generated bin quantity for each MB, so that the state of the buffer 33 in the encoding device 11 is managed.

The picture processing unit 31 includes an allowable generated bin quantity calculating unit 51, a threshold processing unit 52, a coefficient setting unit 53, and a parameter initializing unit 54.

The allowable generated bin quantity calculating unit 51 calculates a generated bin quantity accumulatable to the buffer 3 (allowable generated bin quantity) for each picture of the input image, based on the maximum accumulation amount of the buffer 33 and the bin quantity (generated bin quantity) generated for each predetermined unit (e.g., one picture) of the input image.

The threshold processing unit 52 determines whether the allowable generated bin quantity calculated by the allowable generated bin quantity calculating unit 51 is smaller than a predetermined threshold.

In a case where the threshold processing unit 52 determines that the allowable generated bin quantity calculated by the allowable generated bin quantity calculating unit 51 is smaller than a predetermined threshold, the coefficient setting unit 53 sets an orthogonal transformation coefficient (hereinafter, simply referred to as a transform coefficient) of the MB obtained by the MB processing unit 32 to a predetermined value. The coefficient setting unit 53 supplies the information giving notice that the transformation coefficient is set to a predetermined value to the MB processing unit 32.

The parameter initializing unit 54 initializes a value (parameter) according to the generated bin quantity generated for each MB processed by the MB processing unit 32 for the allowable generated bin quantity of each picture and supplies the parameter to the MB processing unit 32. This parameter varies whenever MB is processed by the MB processing unit 32, and the generated bin quantity of each MB is controlled according to the change.

The MB processing unit 32 includes a threshold processing unit 61, a Q value increase processing unit 62, a generated bin quantity minimizing unit 63, and a bin generating unit 64.

While the parameter initiated by the parameter initializing unit 54 varies for each MB, the threshold processing unit 61 determines whether the parameter is greater than a predetermined threshold.

In a case where the threshold processing unit 61 determines that the parameter is greater than a first threshold among predetermined thresholds, the Q value increase processing unit 62 increases a quantization parameter associated with quantization of each MB.

In a case where the parameter is determined to be greater than a second threshold among predetermined thresholds by the threshold processing unit 61, the generated bin quantity minimizing unit 63 minimizes a bin quantity generated by the bin generating unit 64 for each MB (generated bin quantity).

The bin generating unit 64 generates bin for each MB and supplies the bin to the buffer 33. In addition, the bin quantity generated by the bin generating unit 4, namely the generated bin quantity, is fed back to the picture processing unit 31.

[Generated Bin Quantity Control Process by the Encoding Device]

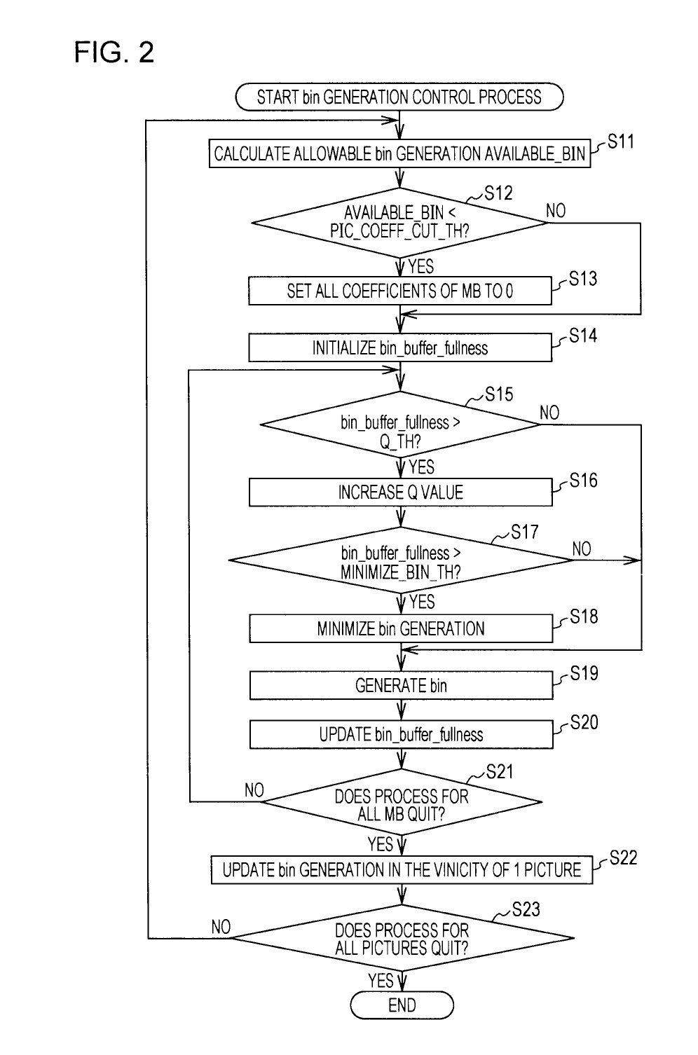

Here, the generated bin quantity control process by the encoding device 11 of FIG. 1 will be described with reference to the flowchart of FIG. 2.

In Step S11, the allowable generated bin quantity calculating unit 51 of the picture processing unit 31 calculates an allowable generated bin quantity AVAILABLE_BIN which is a generated bin quantity accumulatable to the buffer 33, for each picture of the input image, based on the maximum accumulation amount of the buffer 33 and the generated bin quantity generated for one picture of the successively introduced input image.

Here, as a method for managing the buffer 33 in the encoding device 11, a VBR (Variable Bit Rate) mode of a HRD (Hypothetical Reference Decoder) model may be applied. HRD is a virtual model for a video encoder, and is used for controlling the variation of a bit rate of an encoded stream. HRD provides constraints to the bit stream and the video decoder so that an input buffer of the video decoder corresponding to the video encoder does not cause overflow or underflow.

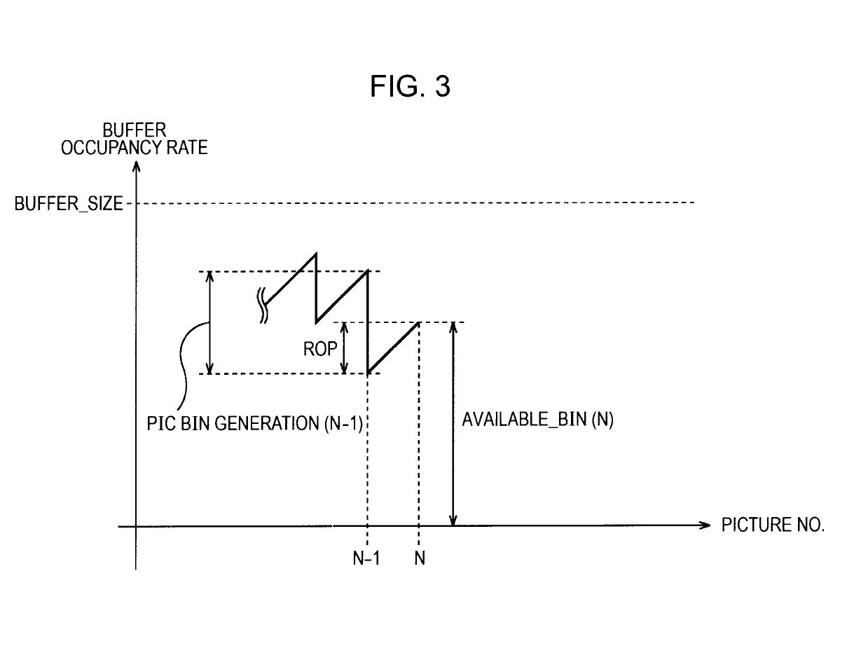

FIG. 3 is a diagram illustrating transition of AVAILABLE_BIN when the HRD model is applied, as a management method of the buffer 33 in the encoding device 11.

As shown in FIG. 3, assuming that a bit quantity supplied to the buffer for each picture in the HRD model is set to ROP (Rate Over Picture) which is the processing ability of the bin for each picture of the CABAC processing unit 34, that the size of the buffer in the HRD model is set to the size of the buffer 33 BUFFER_SIZE in the encoding device 11, and that N is a picture number, an allowable bin for 0^{th} picture AVAILABLE_BIN(0) and an allowable bin for N^{th} picture are expressed as follows.

AVAILABLE_BIN(0)=BUFFER_SIZE-BUFFER initial occupancy (1)

AVAILABLE_BIN(N)=AVAILABLE_BIN(N−1)+ROP-PIC generated bin quantity(N−1) (2)

In addition, the PIC generated bin quantity(N−1) represents a generated bin quantity actually generated for the (N−1)^{th} picture.

By doing so, an allowable generated bin quantity AVAILABLE_BIN is calculated for every picture.

In addition, since the allowable generated bin quantity AVAILABLE_BIN for each picture is necessary to be clipped with the size of the buffer 33 BUFFER_SIZE as an upper limit, if the calculated AVAILABLE_BIN exceeds BUFFER_SIZE, AVAILABLE_BIN(N)=BUFFER_SIZE.

Referring to the flowchart of FIG. 2 again, in Step S12, the threshold processing unit 52 determines whether AVAILABLE_BIN calculated by the allowable generated bin quantity calculating unit 51 is smaller than the threshold PIC_COEFF_CUT_TH.

Here, the threshold PIC_COEFF_CUT_TH will be described. In the encoding process based on the AVC standard, since a minimum generated bin quantity MB_MIN_BIN generated for each MB and the MB number MB_NUM for each picture may be recognized before the picture to be encoded is encoded, the minimum generated bin quantity PIC_MIN_BIN generated for each picture is represented as follows.

PIC_MIN_BIN=MB_MIN_BIN×MB_NUM (3)

In addition, in the case of I slice, MB_MIN_BIN becomes the generated bin quantity when all prediction mode is set to DC prediction and all transformation coefficients are set to 0, and in the case of P slice or B slice, MB_MIN_BIN becomes the generated bin quantity when the prediction mode is set to a skip mode.

The threshold PIC_COEFF_CUT_TH is set to determine how much margin the allowable generated bin quantity AVAILABLE_BIN for each picture has for the minimum generated bin quantity PIC_MIN_BIN of the picture to be encoded. As PIC_MIN_BIN gets closer to AVAILABLE_BIN, the buffer 33 comes to have no margin, which increases the possibility of overflow, thus the quality of a finally output image may be deteriorated. Therefore, the threshold PIC_COEFF_CUT_TH is set as follows with some margin MARGIN.

PIC_COEFF_CUT_TH=(PIC_MIN_BIN+MARGIN)×α (4)

Here, the value α becomes a balancing value which may be set arbitrarily. In addition, the margin MARGIN is set in consideration of a dislocation DELAY between the generated bin quantity of an actually processed MB and the generated bin quantity of a recognizable MB, in the encoding process of the MB processing unit 32, and is expressed as follows by using the maximum generated bin quantity MB_MAX_BIN generated for each MB.

MARGIN=MB_MAX_BIN×DELAY (5)

However, referring to the flowchart of FIG. 2 again, in Step S12, if it is determined that AVAILABLE_BIN becomes smaller than PIC_COEFF_CUT_TH, in other words in a case where the possibility of overflow in the buffer 33 is high, the process proceeds to Step S13.

In Step S13, the coefficient setting unit 53 sets all transform coefficients of a picture encoded by the MB processing unit 32 for the MB to 0, and supplies the information giving notice that the transformation coefficient is set to 0 to the MB processing unit 32. In other words, in the MB processing unit 32, a residual image of the encoding process is ignored, and the picture becomes identical to the predicted image. By doing so, the generated bin quantity may be reduced, the overflow of the buffer 33 may be prevented, and the deterioration of image quality when overflow occurs may be prevented, thereby maintaining the image quality.

In addition, in Step S12, in a case where AVAILABLE_BIN is determined to not be smaller than PIC_COEFF_CUT_TH, Step S13 is skipped.

In Step S14, the parameter initializing unit 54 initializes parameters bin_buffer_fullness according to the generated bin quantity generated for each MB processed by the MB processing unit 32 with respect to AVAILABLE_BIN, and supplies the parameters to the MB processing unit 32. bin_buffer_fullness is a parameter representing that the margin of the buffer 33 decreases (the buffer 33 occupies) as its value increases. Here, bin_buffer_fullness is initialized to bin_buffer_fullness_{—}0 described later.

bin_buffer_fullness_{—}0=PIC_MIN_BIN+MARGIN-AVAILABLE_BIN(0) (6)

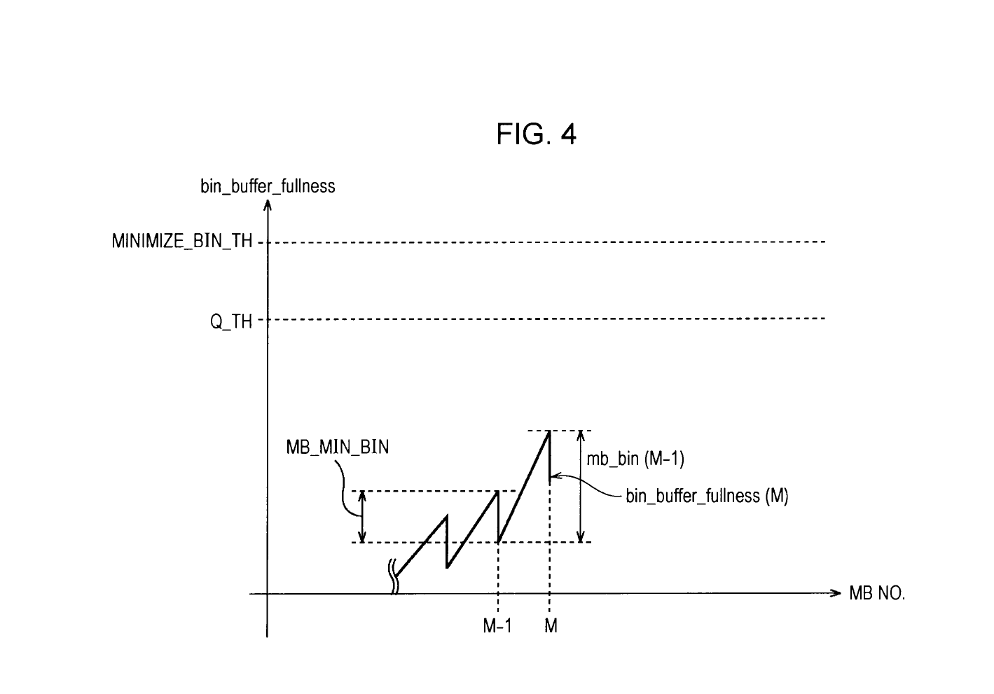

In addition, bin_buffer_fullness varies whenever MB is processed by the MB processing unit 32. Here, the transition of bin_buffer_fullness varying whenever MB is processed will be described with reference to FIG. 4.

As shown in FIG. 4, assuming that the MB number (MB No) is set to be M and the generated bin quantity mb_bin for actually processed MB and the minimum generated bin quantity MB_MIN_BIN for each MB are used, bin_buffer_fullness(M) for the M^{th} MB is expressed as follows.

bin_buffer_fullness(0)=bin_buffer_fullness_{—}0 (7)

bin_buffer_fullness(M)=bin_buffer_fullness(M−1)+mb_bin(M−1)−MB_MIN_BIN (8)

After that, in a case where bin_buffer_fullness representing the degree of occupancy of the buffer 33 increases more than a predetermined threshold, a process is performed so that overflow does not occur in the buffer 33.

Referring to the flowchart of FIG. 2 again, in Step S15, the threshold processing unit 61 of the MB processing unit 32 determines whether bin_buffer_fullness is greater than the threshold Q_TH.

The threshold Q_TH is set to determine how much margin AVAILABLE_BIN has with respect to the minimum generated bin quantity MB_MIN_BIN for the MB to be encoded, and is for example expressed as follows.

Q_TH=bin_buffer_fullness_{—}0xβ (9)

Here, the value β becomes a balancing value which may be arbitrarily set, and is for example a value satisfying 0<β<1.

In Step S15, in a case where bin_buffer_fullness is determined to be greater than the threshold Q_TH, the process proceeds to Step S16, and the Q value increase processing unit 62 increases (magnifies) a quantization parameter (Q value) which determines a quantization step for the MB to be quantized. For H.264/AVC, the Q value is determined for each MB.

By doing so, since the transformation coefficient may be reduced by increasing the Q value of MB, the generated bin quantity may decrease for MB after the MB to be quantized, thereby preventing overflow from occurring in the buffer 33.

After Step S16, the process proceeds to Step S17, and the threshold processing unit 61 of the MB processing unit 32 determines whether bin_buffer_fullness is greater than the threshold MINIMIZE_BIN_TH.

The threshold MINIMIZE_BIN_TH is set to determine how much margin AVAILABLE_BIN has with respect to the minimum generated bin quantity MB_MIN_BIN for the MB to be encoded, similar to the threshold Q_TH, and for example is expressed as follows.

MINIMIZE_BIN_TH=bin_buffer_fullness_{—}0x γ (10)

Here, the value γ becomes a balancing value which may be arbitrarily set. In addition, as shown in FIG. 4, the threshold MINIMIZE_BIN_TH becomes a value greater than the threshold Q_TH.

In Step S17, in a case where bin_buffer_fullness is determined to be greater than the threshold MINIMIZE_BIN_TH, the process proceeds to Step S18, and the generated bin quantity minimizing unit 63 minimizes the generated bin quantity generated for each MB by the bin generating unit 64. In detail, in the case of I slice, the generated bin quantity minimizing unit 63 sets all prediction modes to DC prediction and sets all transform coefficients to 0, and in the case of P slice or B slice, the generated bin quantity minimizing unit 63 sets the prediction to a skip mode.

By doing so, the generated bin quantity may be reduced, and it is possible to prevent overflow from occurring in the buffer 33.

After Step S18, or in a case where bin_buffer_fullness is determined in Step S15 to not be greater than the threshold Q_TH or determined in Step S17 to not be greater than the threshold MINIMIZE_BIN_TH, the process proceeds to Step S19.

In Step S19, the bin generating unit 64 generates bin with a generated bin quantity according to the above and supplies the bin to the buffer 33. At this time, the generated bin quantity is fed back to the allowable generated bin quantity calculating unit 51 of the picture processing unit 31.

In Step S20, the MB processing unit 32 updates bin_buffer_fullness.

In Step S21, the MB processing unit 32 determines whether all MB for one picture are processed. In a case where all MB for one picture are not yet completely processed, the process returns to Step S15, and the processes of Steps S15 to S21 are repeated.

Meanwhile, in Step S21, in a case where all MB for one picture are completely processed, the process proceeds to Step S22, and the allowable generated bin quantity calculating unit 51 updates a PIC generated bin quantity representing generated bin quantity actually generated for the picture, based on the generated bin quantity for one picture fed back from the bin generating unit 64.

In Step S23, the picture processing unit 31 determines whether all pictures in successively introduced input images are completely processed. In a case where all pictures in the input image are not yet completely processed, the process returns to Step S11, and the processes of Steps S11 to S23 are repeated.

Meanwhile, in Step S23, in a case where all pictures for the input image are determined to be completely processed, the generated bin quantity control process is completed.

According to the above processes, an allowable generated bin quantity AVAILABLE_BIN which is a generated bin quantity accumulatable in the buffer 33 is calculated for each picture of the input image, based on the maximum accumulation amount of the buffer 33 and the generated bin quantity generated for each picture of the successively introduced input image, and the state of the buffer 33 may be managed, so it is possible to prevent a bin beyond the capability of the CABAC processing unit 34 from being supplied to the buffer. Therefore, when CABAC is processed, it is possible to prevent overflow from occurring in the buffer 33, and further it is possible to output a normal bit stream.

In addition, in a decoding device for decoding the bit stream encoded using the CABAC process by the above encoding device 11, the CABAC process is performed on the bit stream, the resultantly obtained bin is accumulated in the buffer, and the decoding processing unit acquires the bin accumulated in the buffer and outputs a decoded image. In the decoding device, the buffer is designed depending on the capacity of the buffer 33 of the encoding device 11.

Here, in a case where the bit stream output by the encoding device 11 and decoded by the decoding device is a bit stream which may cause overflow in the buffer 33, overflow may also occur in a buffer of the decoding device. In this case, the bin flowing to the decoding processing unit is damaged such that the decoding processing unit may not output a normal decoded image. In addition, in the decoding device, the CABAC process may be stopped in order not to cause overflow in the buffer, but in this case, the process is not completed in real time and the decoded image may not be output at a necessary timing.

However, if the above process is used, a normal bit stream may be output by the encoding device, and therefore, even in the decoding device, it is possible to prevent overflow from occurring in the buffer, which allows a normal decoded image to be output.

In addition, since the generated bin quantity may be controlled according to the processing ability of the CABAC processing unit 34 of the encoding device 11, it is possible to predict a necessary capacity of the buffer 33 and to ensure a minimum capacity of the buffer 33. By doing so, it is possible to suppress hardware size or power consumption. In addition, on the contrary, since the capacity of the buffer 33 may be determined, the processing ability of the CABAC processing unit 34 may be predicted accordingly, and it is possible to suppress hardware size or power consumption.

[Smart Rendering Editing Process]

However, in a case where two moving picture materials are cut off and compiled to perform editing, smart rendering editing is performed.

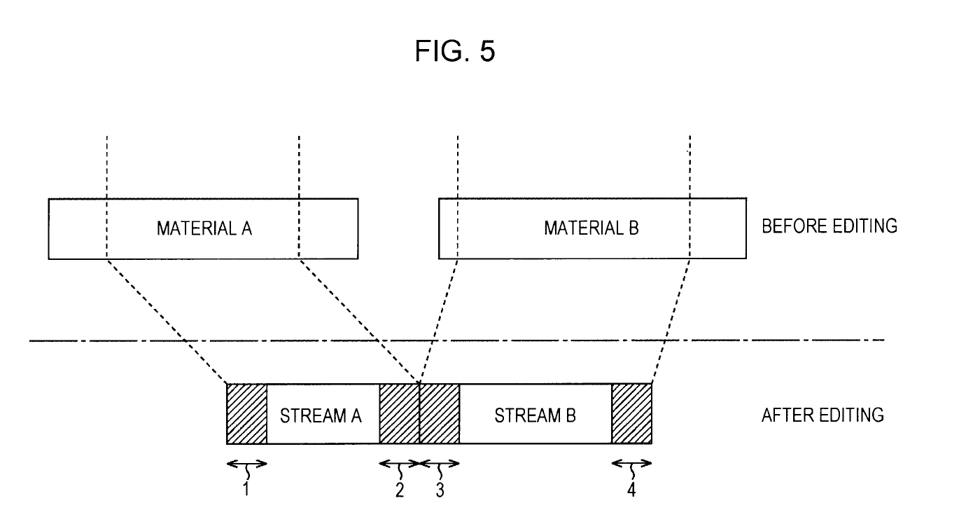

In the smart rendering editing, as shown in FIG. 5, when a stream A cut off from a material A and a stream B cut off from a material B are compiled, the cut streams A and B are not entirely re-encoded (transcoded), but as shown with oblique lines in FIG. 5, only partial portions at both ends are re-encoded. In other words, in the example of FIG. 5, four re-encoding sections are generated as shown by both arrows 1 to both arrows 4.

In the image editing device which performs smart rendering editing as described above, in a case where the CABAC process is used to perform re-encoding, since the generated bin quantity in the re-encoding section where the stream A and the stream B are compiled as indicated by both arrows in FIG. 5 is not known, there is a possibility that overflow may occur in the buffer.

In order to know the generated bin quantity in the re-encoding section where the stream A and the stream B are compiled, the CABAC process should be performed for the entire regions of the material A and the material B. However, In AVC, the CABAC process takes a great deal of time due to the high throughput, and therefore the smart rendering editing takes a great deal of time.

For this reason, hereinafter, in the image editing device performing the smart rendering editing, the configuration of restraining the occurrence of overflow in the buffer will be described.

[Example of Configuration of Image Editing Device]

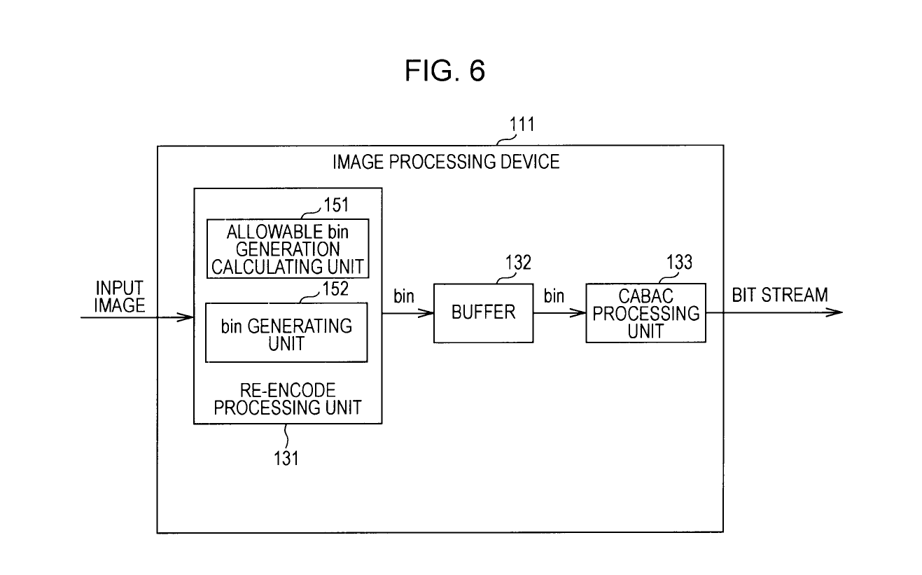

FIG. 6 shows an example of a configuration of the image editing device performing the smart rendering editing.

The image editing device 111 includes a re-encoding processing unit 131, a buffer 132, and a CABAC processing unit 133.

In addition, in the image editing device 111 of FIG. 6, the buffer 132 and the CABAC processing unit 133 basically have the same functions as the buffer 33 and the CABAC processing unit 34 of the encoding device 11 of FIG. 1 and therefore are not described again.

The re-encoding processing unit 131 re-encodes the input image which is input without decoding it. The re-encoding processing unit 131, for example, compiles the stream A and the stream B cut from the material A and the material B shown in FIG. 5 to perform smart rendering editing.

In addition, the re-encoding processing unit 131 includes at least an allowable generated bin quantity calculating unit 151 and a bin generating unit 152, and, for example, controls the generated bin quantity in the re-encoding section where the stream A and the stream B are compiled as shown in FIG. 5. In addition, even in the image editing device 111, as a management method of the buffer 132, the VBR mode of the HRD model is applied.

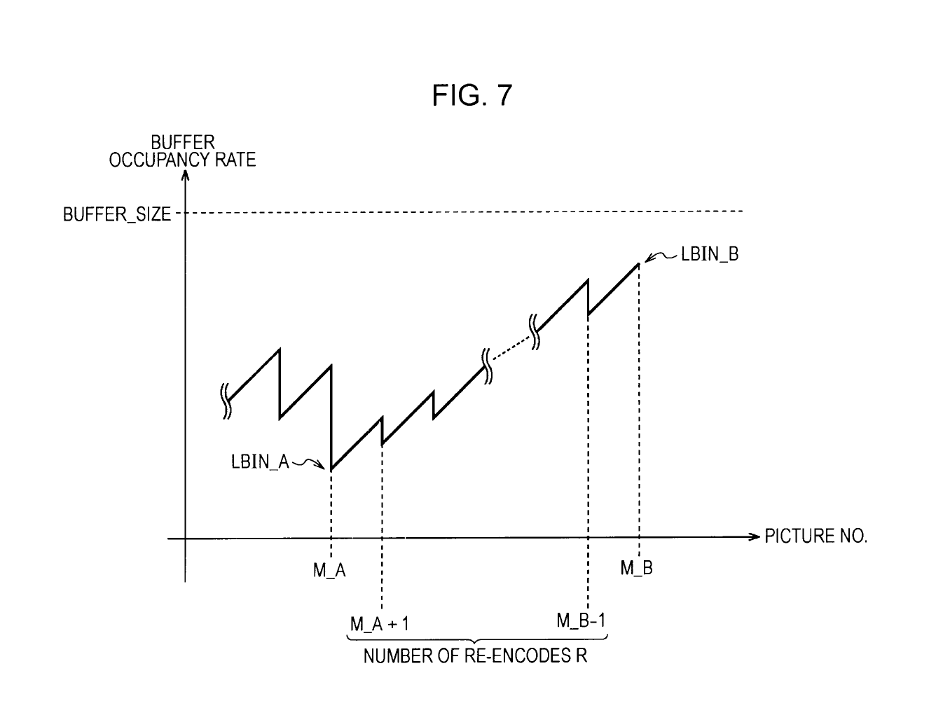

Here, referring to FIG. 7, the transition of the generated bin quantity in the re-encoding section will be described.

As shown in FIG. 7, assuming that a picture number just before the re-encoding section of the stream A is set to be M_A, that a picture number just after the re-encoding section of the stream B is set to be M_B, and that the number of pictures (the number of times of re-encoding) in the re-encoding section is set to be R, a local bin quantity LBIN_A in the buffer 132 just before the re-encoding section of the stream A and a local bin quantity LBIN_B in the buffer 132 just after the re-encoding section of the stream B are expressed as follows.

LBIN_{—}A=AVAILABLE_BIN(M_{—}A)-PIC generated bin quantity(M_{—}A) (11)

LBIN_{—}B=AVAILABLE_BIN(M_{—}B) (12)

In addition, in FIG. 7, the relationship M_B=M_A+R is established.

In other words, in the image editing device 111, in order that the buffer 132 does not overflow, it is preferable to control the generated bin quantity generated in the re-encoding process for R number of pictures.

[Generated Bin Quantity Control Process by the Image Editing Device]

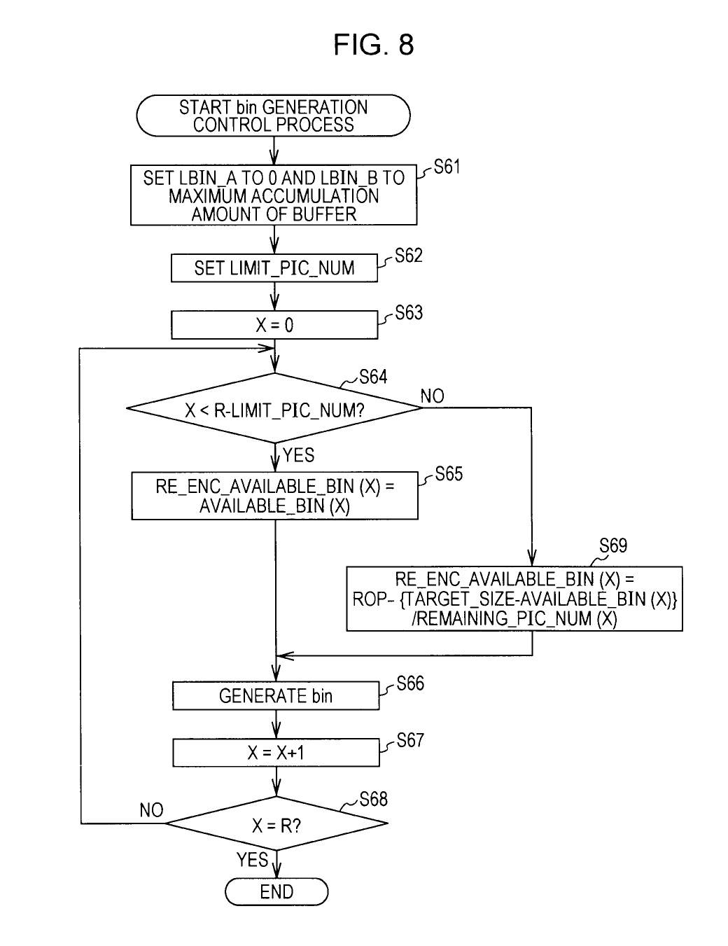

Here, referring to the flowchart of FIG. 8, the generated bin quantity control process by the image editing device 111 of FIG. 6 will be described.

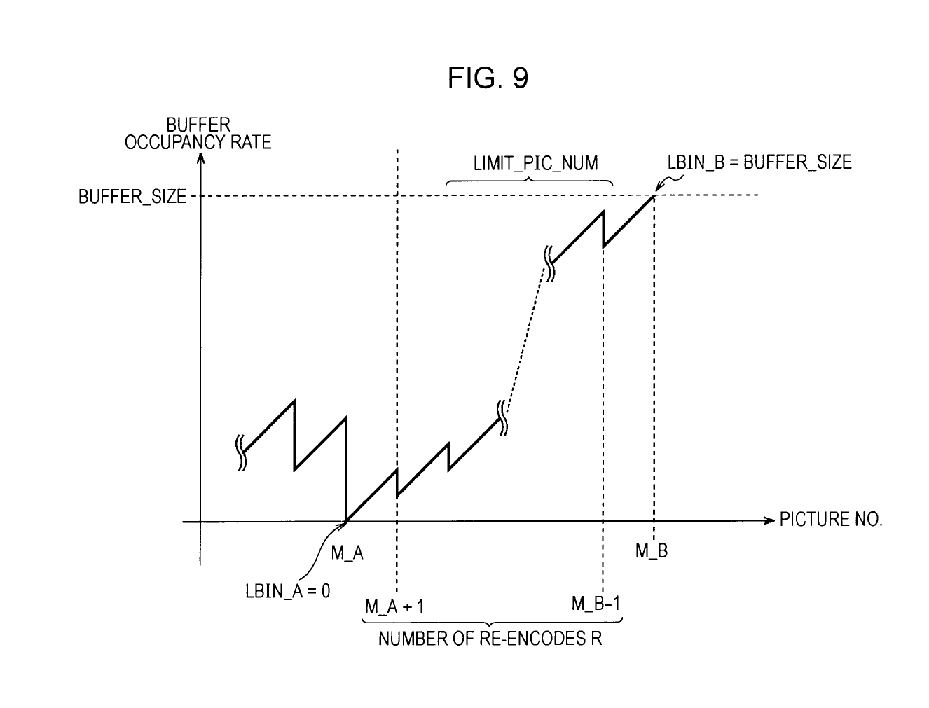

In Step S61, the allowable generated bin quantity calculating unit 151 sets LBIN_A to be 0 and sets LBIN_B to be a maximum accumulation amount of the buffer 132, as shown in FIG. 9. By doing so, for the (M_A+1)^{th} picture and the M_B^{th} picture, the following relationship is established.

$$\begin{matrix}\begin{matrix}AVAILABLE\_BIN ( M\_A + 1 ) = AVAILABLE\_BIN ( M\_A ) + \\ ROP - PIC \\ generated bin \\ quantity ( M\_A ) \\ = LBIN\_A + ROP \\ = ROP\end{matrix} & ( 13 ) \\ AVAILABLE\_BIN ( M\_B ) = BUFFER\_SIZE & ( 14 )\end{matrix}$$

In Step S62, the allowable generated bin quantity calculating unit 151 sets the number of pictures LIMIT_PIC_NUM which restrains the generated bin quantity in order to satisfy the above equations (13) and (14). Here, it becomes LIMIT_PIC_NUMR.

In Step S63, the allowable generated bin quantity calculating unit 151 sets the picture number X of a picture, which will be re-encoded, to be 0.

In Step S64, the allowable generated bin quantity calculating unit 151 determines whether X<R-LIMIT_PIC_NUM.

In Step S64, in a case where it is determined that X<R-LIMIT_PIC_NUM, the process proceeds to Step S65, and the allowable generated bin quantity calculating unit 151 sets the allowable generated bin quantity RE_ENC_AVAILABLE_BIN(X) of each picture in the re-encoding section to be AVAILABLE_BIN(X). In addition, AVAILABLE_BIN(X) is calculated by the same process as in Step S11 in the flowchart of FIG. 2.

In Step S66, the bin generating unit 152 generates bin of a generated bin quantity according to RE_ENC_AVAILABLE_BIN(X) calculated by the allowable generated bin quantity calculating unit 151. At this time, the bin generating unit 152 transforms a stream (bit) into bin based on a predetermined transformation table to generate bin. By using such a transform table, it is possible to reduce the amount of calculations necessary for the re-encoding process.

In Step S67, the allowable generated bin quantity calculating unit 151 increases X by 1.

In Step S68, the allowable generated bin quantity calculating unit 151 determines whether X=R, namely whether the picture to be re-encoded is a final picture in the re-encoding section.

In Step S68, in a case where it is not determined that

X=R, the process returns to Step S64, and the processes of Steps S64 to S68 are repeated.

In addition, in Step S64, in a case where it is not determined that X<R-LIMIT_PIC_NUM, in other words in a case where it is determined that X≧n-LIMIT_PIC_NUM, the process proceeds to Step S69.

In Step S69, the allowable generated bin quantity calculating unit 151 sets RE_ENC_AVAILABLE_BIN(X) as follows.

RE_ENC_AVAILABLE_BIN(X)=ROP-{TARGET_SIZE-AVAILABLE_BIN(X)}/REMAINING_PIC_NUM(X) (15)

Here, TARGET_SIZE is a target accumulation amount of the buffer 132, which is identical to BUFFER_SIZE here. In addition, REMAINING_PIC_NUM(X) is the number of remaining pictures in the re-encoding section, and REMAINING_PIC_NUM(X)=R−X.

After Step S69, the process proceeds to Step S66, and the bin generating unit 152 generates bin of the generated bin quantity according to RE_ENC_AVAILABLE_BIN(X) calculated by the allowable generated bin quantity calculating unit 151, based on a predetermined transformation table.

Meanwhile, in Step S67, in a case where it is determined that X=R, in other words in a case where the process for pictures in the re-encoding section is completed, the generated bin quantity control process ends.

According to the above processes, in the smart rendering editing where the stream A and the stream B are compiled, the generated bin quantity LBIN_A in the buffer 132 for the picture just before the re-encoding section of the stream A is set to be 0, the generated bin quantity LBIN_B in the buffer 132 for the picture just after the re-encoding section of the stream B is set to be a maximum accumulation amount of the buffer 132, and the allowable generated bin quantity RE_ENCAV_AVAILABLE_BIN(X) for each picture in the re-encoding section is calculated to satisfy them. Therefore, the generated bin quantity in the re-encoding section does not exceed the maximum accumulation amount of the buffer 132, it is possible to prevent overflow from occurring in the buffer 132, and further it is possible to output a normal bit stream.

In addition, since it is not necessary to perform the CABAC process for all regions of the material A and the material B in order to know the generated bin quantity of the re-encoding section where the stream A and the stream B are compiled, it is possible to reduce the time taken for smart rendering editing in the AVC.

In addition, even though it has been described that the VBR mode of the HRD model is applied to calculate the allowable generated bin quantity of the buffer so as to control the generated bin quantity as a method for managing the state of the buffer, other methods may also be used. For example, the state of the buffer may be managed by controlling the generated bin quantity based on, for example, the size of the buffer, the processing ability of the CABAC processing unit, the minimum generated bin quantity (MB_MIN_BIN) generated for each MB, or the like.

The generated bin quantity control process described above may be executed by hardware or software. In a case where a series of processes is executed by software, a program configuring the software is installed from a program recording medium to a computer included in dedicated hardware, or for example, a general personal computer which may execute various functions by installing various kinds of program.

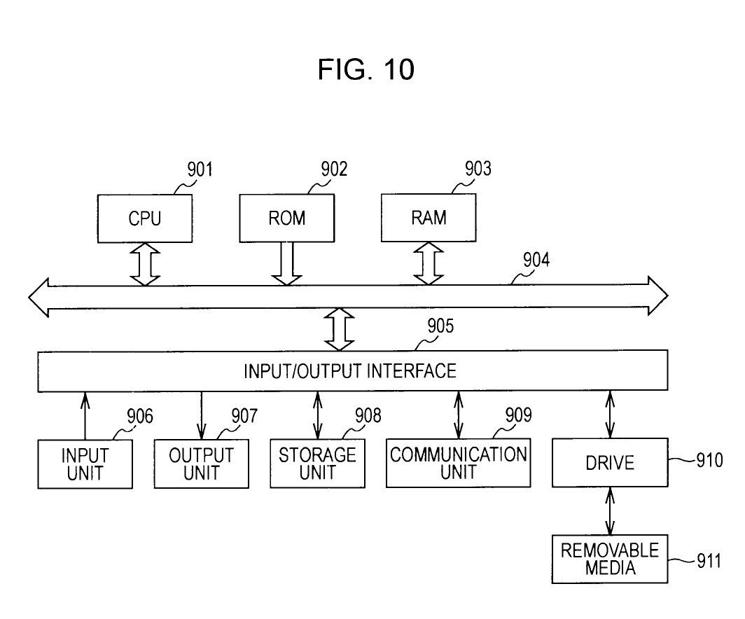

FIG. 10 is a block diagram showing an example of a hardware configuration of a computer which executes the series of processes described above by a program.

In the computer, a CPU (Central Processing Unit) 901, a ROM (Read Only Memory) 902, and a RAM (Random Access Memory) 903 are connected to each other by a bus 904.

An input/output interface 905 is connected to the bus 904. An input unit 906 composed of a keyboard, a mouse, a microphone or the like, an output unit 907 composed of a display, a speaker or the like, a storage unit 908 composed of a hard disk, a non-volatile memory or the like, a communication unit 909 composed of a network interface or the like, and a drive 910 for driving a removable media 911 such as a magnetic disk, an optical disc, a magneto-optical disc, a semiconductor memory or the like are connected to the input/output interface 905.

In a computer configured as described above, the CPU 901 loads and executes, for example, programs stored in the storage unit 908 on the RAM 903 by means of the input/output interface 905 and the bus 904 to perform a series of processes as described above.

The program executed by the computer (CPU 901) is recorded on, for example, a removable media 911 which is a package media composed of a magnetic disk (including a flexible disk), an optical disc (CD-ROM (Compact Disc-Read Only Memory), a DVD (Digital Versatile Disc) or the like), a magneto-optical disc, a semiconductor or the like, or is provided through a wired or wireless transmission medium such as a local area network, the Internet, a digital satellite broadcasting, or the like.

In addition, the program may be installed to the storage unit 908 through the input/output interface 905 by mounting the removable media 911 to the drive 910. In addition, the program may be received to the communication unit 909 through a wired or wireless transmission medium and installed to the storage unit 908. Moreover, the program may be installed to the ROM 902 or the storage unit 908 in advance.

In addition, the program executed by the computer may be a program which performs time series processes in the order described herein or a program which performs processes in parallel or performs a process at necessary timing when the process is called.

In addition, the embodiments of the present disclosure are not limited to the above description, and various modifications can be made without departing from the spirit of the present disclosure.

The present disclosure contains subject matter related to that disclosed in Japanese Priority Patent Application JP 2010-287964 filed in the Japan Patent Office on Dec. 24, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus which accumulates information generated corresponding to an input image in a buffer and obtains the accumulated information to perform arithmetic encoding, the image processing apparatus comprising:
a calculating unit which calculates an allowable quantity of the information accumulatable in the buffer for each predetermined unit of the input image, based on a maximum accumulation amount of the buffer and an information quantity of the information generated for each predetermined unit of the input unit; and
a generating unit which generates the information with an information quantity according to the allowable quantity calculated by the calculating unit.

2. The image processing apparatus according to claim 1, further comprising a coefficient setting unit which sets all coefficients for a macro block in the input image to be 0 (zero), in a case where the allowable quantity calculated for each picture of the input image is smaller than a predetermined threshold.

3. The image processing apparatus according to claim 1, further comprising a parameter adjusting unit which increases a quantization parameter value of the macro block, in a case where a value according to the information quantity of the information generated for each macro block of the input unit for the allowable quantity calculated for each picture of the input image is greater than a first threshold.

4. The image processing apparatus according to claim 3, further comprising a minimizing unit that minimizes the information quantity of the information generated for each macro block, in a case where a value corresponding to the information quantity of the information generated for each macro block of the input image for the allowable quantity calculated for each picture of the input image is greater than a second threshold which is different from the first threshold.

5. The image processing apparatus according to claim 1, wherein, in an editing process for cutting and compiling a first input image and a second input image, in a case where a region where the first input image and the second input image are compiled is re-encoded,
the calculating unit sets a first information quantity in the buffer for a picture just before the re-encoding region in the first input image to be 0 (zero), sets a second information quantity in the buffer for a picture just after the re-encoding section in the second input image to be a maximum accumulation amount of the buffer, and calculates the allowable quantity for each picture in the re-encoding section for the first input image and the second input image.

6. The image processing apparatus according to claim 1, wherein the calculating unit calculates the allowable quantity of the information accumulatable in the buffer by applying an HRD (Hypothetical Reference Decoder) model.

7. An image processing method of an image processing apparatus which accumulates information generated corresponding to an input image to a buffer and obtains the accumulated information to perform arithmetic encoding, the image processing method comprising:
calculating an allowable quantity of the information accumulatable in the buffer for each predetermined unit of the input image, based on a maximum accumulation amount of the buffer and an information quantity of the information generated for each predetermined unit of the input unit; and
generating the information with an information quantity according to the allowable quantity calculated by the calculating.
